(19) United States
(12) Patent Application Publication
(10) Pub. No.: US 2022/0410706 A1
(43) Pub. Date: Dec. 29, 2022

(54) SYSTEM FOR INTUITIVE HUMAN-MACHINE INTERFACE

(71) Applicant: WIESS CORPORATION, Taipei City (TW)

(72) Inventor: HUNG-YUAN HUNG, Taipei City (TW)

(73) Assignee: WIESS CORPORATION, Taipei City (TW)

(21) Appl. No.: 17/580,137

(22) Filed: Jan. 20, 2022

(30) Foreign Application Priority Data
Jun. 29, 2021 (TW) 110123794

(51) Int. Cl. B60K 35/00; B60R 16/023; G07C 5/08

(52) U.S. Cl. CPC B60K 35/00; B60R 16/0231; G07C 5/0825; G07C 5/0833; B60K 2370/1529; B60K 2370/164; B60K 2370/166; B60K 2370/178; B60K 2370/169; B60K 2370/1575; B60K 2370/158; B60K 2370/349

(57) ABSTRACT

This invention provides a system for intuitive human-machine interface. The system includes a visual device, an audio device, a haptic device, and a system of chip. The system of chip receives a data transmitted from one of the following groups including at least one electronic control unit, an advanced driver assistance system, a center informative display, and at least one communication system. It determines a first feedback level to which the data matches and drives the visual device, the audio device, and the haptic device to perform difference feedback operations according to the first feedback level, to provide an intuitive cognition message to a driver.

### BACKGROUND OF THE INVENTION

### 1. Field of the Invention

The present invention relates to the field of vehicle dashboard system, more particularly, to an intuitive sensory feedback interface system used in vehicle dashboard, with multiple sensory feedback technology, the present invention provides operations of an intuitive human-machine interface interacting with vehicle driver.

### 2. Description of the Prior Art

In nowdays, dozens of Electronic Control Unit (ECU) are used in a car to receive information feedback from corresponding sensor or to control corresponding device. The most common device is the engine controller, in addition, transmission, air bag, anti-lock braking system (ABS), cruise control, power steering, audio system, power car window, power car door, power rear mirror, battery and hybrid electric vehicle power charging system, and so forth, all of these devices use Electronic Control Unit (ECU). In these ECUs, some of them are operated independently, while some others need to interact with other ECUs to complete operations, and results of operations need to be displayed on the car dashboard to show to the car driver, so the car driver can proceed proper operations accordingly.

### SUMMARY OF THE INVENTION

However, the traditional analog car dashboard is not able to handle such massive information created by multiple ECUs, so, the digital car dashboard can be a possible and ideal solution. Comparing with the traditional analog car dashboard, multi-media and basic vehicle information can be fully integrated and properly, preciously displayed on the digital car dashboard. With modern digital technology, the traditional analog car dashboard can be simulated to display Global Positioning System (GPS) navigation system, multi-media play list, communication list, integrated journey information, vehicle oil temperature and battery voltage, and other information so on, on a digital car dashboard.

The car dashboard is one of the important safety components in the car, therefore, the importance of human-computer interaction is needed to be focused seriously. Three major goals of the design of hardware and software in the use of human-machine interface must be achieved, including, the use of convenience, rationality and controllability. Due to various interfaces and vehicle information are diversified and scattered, plus On-Board Diagnostics (OBD, Advanced Driver Assistance System (ADAS), etc. the driving information showing to the car driver is sometime messy, so it easily causes the driver driving-senses overloaded, in other words, the driver could be not able to effectively recognize the importance of vehicle information in a short time to take appropriate actions, which seriously affect the safety of driving a car.

Moreover, system developments of plenty of ECUs must be integrated with multiple system provider's solutions, even the specification of interface could be the same, but the test and debug of the compatibility usually causes massive time and manpower, and some low level ECUs using distributing computing not only consumes electric power but also act slow, which is another drawback.

Therefore, providing an intuitive human-computer interactive interface dashboard system through the multiple sensory interfaces to make the different intuitive sensory feedback allows the driver to recognize the priority of importance of vehicle information in short time and take appropriate actions, and providing an intuitive human-computer interaction platform to effectively integrate multiple ECUs to reduce electric power consumption and to improve computing performance and reduce latency time, and simplify the various and complicated vehicle information with a single criterion, are the major obvious effects of the present invention.

According one preferred embodiment of the present invention, which provides a system for intuitive human-machine interface. The system includes a visual device, an audio device, a haptic device, and a system of chip receiving a data transmitted from one of the following units including at least one electronic control unit, an advanced driver assistance system, a center informative display, and at least one communication system to determines correspondingly a first feedback level to drive the visual device, the audio device, and the haptic device to perform difference feedback operations according to the first feedback level, and to provide an intuitive cognition message to a driver.

In this preferred embodiment, the system of chip receiving at least one data transmitted from at least one of the following plurality of units including a plurality of electronic control units, the advanced driver assistance system, a center informative display, and a plurality of communication systems to determines correspondingly a second feedback level to drive the visual device, the audio device, and the haptic device to perform difference feedback operations according to the second feedback level, and to provide an intuitive cognition message to a driver.

In this preferred embodiment, the visual device comprises a Head-Up Display (HUD), the HUD performs difference feedback operations, including low brightness on, low brightness flickering, high brightness flickering and high brightness fast flickering, to provide the driver the intuitive feedback of different visual effect.

In another preferred embodiment, the visual device comprises a LCD display screen, the LCD display screen performs difference feedback operations, including low brightness on, low brightness flickering, high brightness flickering and high brightness fast flickering, to provide the driver the intuitive feedback of different visual effect.

In this embodiment, the audio device comprises a car audio, the car audio performs difference feedback operations, including no action, low reminding sound, high short reminding sound, and high short fast reminding sound, to provide the driver the intuitive feedback of different audio effect.

In another embodiment, the car audio performs difference feedback operations, including human voice and/or computer voice reminding operations, to provide the driver the intuitive feedback of different audio effect.

In one embodiment, the haptic device comprises the center informative display that performs difference feedback operations, including no action, short vibration, constant short vibrations, and constant long vibrations, to provide the driver the intuitive feedback of different haptic effect.

In one embodiment, the communication system comprises Blue Tooth, Global Positioning System (GPS) and 5G communication.

In one embodiment, the data and the plurality of data are transmitted by one of the following protocols or their combination, including Universal Asynchronous Receiver/Transmitter (UART), Controller Area Network (CAN), On-Board Diagnostics (OBD), Blue Tooth, GPS and 5G communication.

### BRIEF DESCRIPTION OF THE DRAWINGS

The present invention can be more fully understood by reading the following detailed description of the preferred embodiments, with reference made to the accompanying drawings, wherein:

FIG. 1 shows a block diagram according to a preferred embodiment of the present invention; and

FIG. 2 shows a block diagram according to another preferred embodiment of the present invention.

### DETAILED DESCRIPTION OF THE PREFERRED EMBODIMENTS

Some embodiments of the present invention are described in detail below. However, in addition to the descriptions given below, the present invention can be applicable to other embodiments, and the scope of the present invention is not limited by such, rather by the scope of the claims. Moreover, for better understanding and clarity of the description, some components in the drawings may not necessary be drawn to scale, in which some may be exaggerated relative to others, and irrelevant parts are omitted.

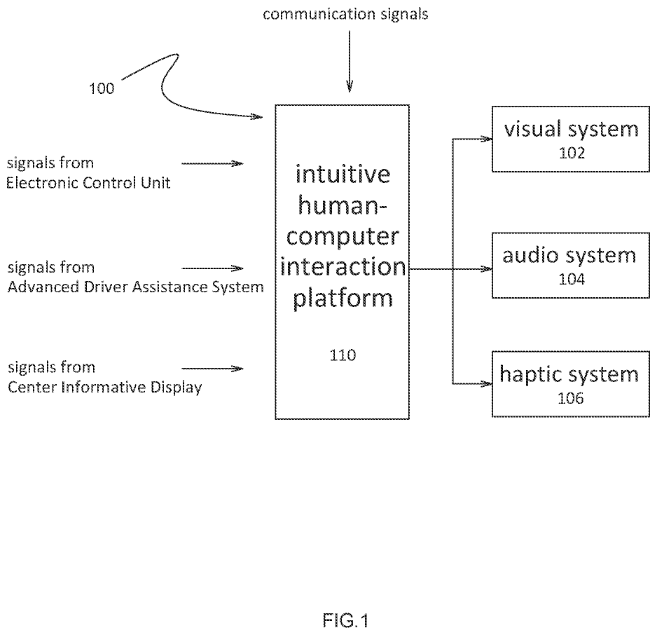

Please refer to FIG. 1, which is a block diagram 100 of one preferred embodiment according to the present invention. In FIG. 1, an intuitive human-computer interaction platform 110 receives at least one or a plurality of signals from Electronic Control Unit (ECU), Advanced Driver Assistance System (ADAS), Center Informative Display (CID), and so forth, wherein, the signal(s) from ECU may be one single or multiple vehicle information generated by a single ECU, or may be multiple vehicle information generated by multiple ECUs, meanwhile, the signal(s) may be a single one or multiple ones transmitted simultaneously or sequentially to the intuitive human-computer interaction platform 110, but the scenario herein is not the limitations of the present invention.

After the intuitive human-computer interaction platform 110 received the signals, identification of formula training is used to determine if the signals involve many variables, and the severity, exposure rate, and controllability of the various events the signals representing would be calculated immediately based on predetermined rules or through a message priority algorithm, and all of the safety level the vehicle information represented by the signals would be graded.

After grading the safety level, the intuitive human-computer interaction platform 110 will initial, based on the grade of safety level, a visual system 102, an audio system 104 and a haptic system 106 to performs difference intuitive sensory feedback operations, to provide the driver the different level of intuitive sensory feedback in visual, audio and haptic aspects.

In one embodiment of the present invention, the visual system 102 may comprises a Head-Up Display (HUD), the HUD performs difference feedback operations, including low brightness on, low brightness flickering, high brightness flickering and high brightness fast flickering, and in another embodiment of the present invention, the visual system 102 may comprises a LCD display screen, the LCD display screen performs difference feedback operations, including low brightness on, low brightness flickering, high brightness flickering and high brightness fast flickering, to provide the driver the different level of intuitive sensory feedback in visual aspect.

In one embodiment of the present invention, the audio system 104 comprises a car audio, the car audio performs difference feedback operations, including no action, low reminding sound, high short reminding sound, and high short fast reminding sound, and in another embodiment of the present invention, the car audio performs difference feedback operations, including human voice and/or computer voice reminding operations, to provide the driver the different level of intuitive sensory feedback in audio aspect.

In one embodiment of the present invention, the haptic system 106 comprises a center informative display that performs difference feedback operations, including no action, short vibration, constant short vibrations, and constant long vibrations, to provide the driver the different level of intuitive sensory feedback in haptic aspect.

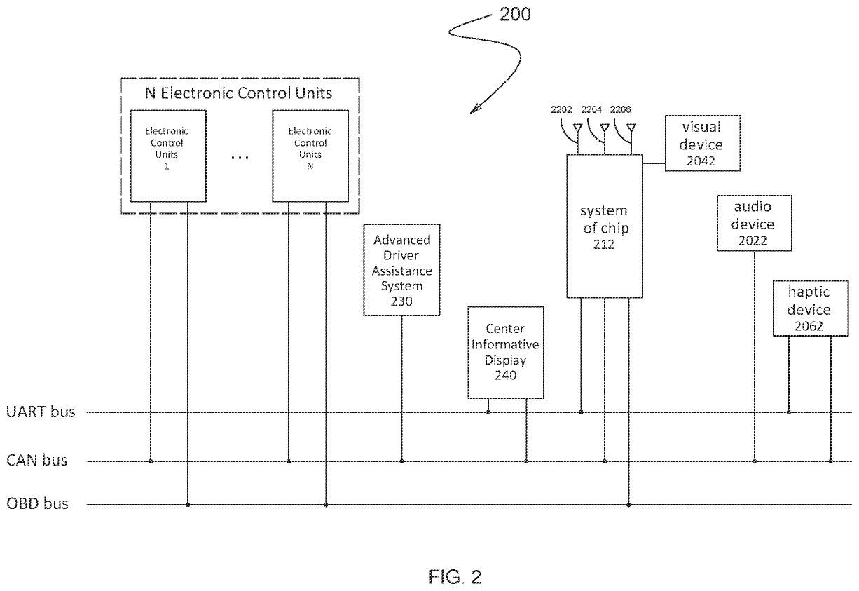

Please refer to FIG. 2, which is a block diagram 200 of one preferred embodiment according to the present invention. In FIG. 2, a system of chip 212 receives at least one or a plurality of signals from one ECU (Electronic Control Unit) or multiple ECUs (ECU 1˜ECU N, N is integer), signals from an Advanced Driver Assistance System (ADAS) 230, signals from a Center Informative Display (CID) 240 and/or signals from multiple communication channels, wherein, the single(s) from ECU may be single one or multiple vehicle information transmitted by a single ECU, or may be multiple vehicle information transmitted by multiple ECUs, meanwhile, the signals may be single one or multiple vehicle information transmitted by the an Advanced Driver Assistance System (ADAS) 230, the signals may be single one or multiple vehicle information transmitted by the Center Informative Display (CID) 240, or the signals may be single one or multiple vehicle information from one of multiple communication channels or from multiple communication channels or the combination of the signals mentioned above. the signal(s) may be a single one or multiple ones transmitted to system of chip 212 simultaneously or sequentially via one of the following protocols or their combination, including Universal Asynchronous Receiver/Transmitter (UART), Controller Area Network (CAN), On-Board Diagnostics (OBD), Bluetooth (antenna 2202), GPS (antenna 2204) and 5G communication (antenna 2206), but the scenario herein is not the limitations of the present invention.

After the system of chip 212 received the signals, it would perform the same operations as proceed in the intuitive human-computer interaction platform 110, therefore, herein details not repeated any more. After grading the safety level, the system of chip 212 will initial, based on the grade of safety level, a visual system 2022, an audio system 2042 and a haptic system 2062 to performs difference intuitive sensory feedback operations, to provide the driver the different level of intuitive sensory feedback in visual, audio and haptic aspects.

In one embodiment of the present invention, the visual system 2022 may comprises a Head-Up Display (HUD), the HUD performs difference feedback operations, including low brightness on, low brightness flickering, high brightness flickering and high brightness fast flickering, and in another embodiment of the present invention, the visual system 2022 may comprises a LCD display screen, the LCD display screen performs difference feedback operations, including low brightness on, low brightness flickering, high brightness flickering and high brightness fast flickering, to provide the driver the different level of intuitive sensory feedback in visual aspect.

In one embodiment of the present invention, the audio system 2042 comprises a car audio, the car audio performs difference feedback operations, including no action, low reminding sound, high short reminding sound, and high short fast reminding sound, and in another embodiment of the present invention, the car audio performs difference feedback operations, including human voice and/or computer voice reminding operations, to provide the driver the different level of intuitive sensory feedback in audio aspect.

In one embodiment of the present invention, the haptic system 2062 comprises a center informative display that performs difference feedback operations, including no action, short vibration, constant short vibrations, and constant long vibrations, to provide the driver the different level of intuitive sensory feedback in haptic aspect.

In the embodiment, the system of chip 212 uses CAN (Controller Area Network) bus to drive visual device 2022 to perform difference intuitive sensory feedback operations, and in another embodiment, the system of chip 212 could output its own video signal to drive the visual device 2022 to perform difference sensory feedback operations, more, the system of chip 212 could use CAN (Controller Area Network) bus or UART (Universal Asynchronous Receiver/Transmitter) bus to drive the haptic system 2062 to perform difference sensory feedback operations, or, the system of chip 212 could use its own I/O interface to directly drive the haptic device 2062 to perform difference sensory feedback operations, the above scenarios are not the limitations of the present invention but all depending on the power requirement and interface specification of the visual device 2022 and the haptic device 2062.

The present invention provides an intuitive human-machine interface operations and a real time multi-interfaces difference intuitive sensory feedback operations, to reduce the operation time that the driver operating the dashboard, meanwhile, to make the driver intuitively realize in short time the critical priority the vehicle information representing and further perform appropriate operations, that is, to reduce the driver's reaction time during the driving to response with appropriate operation based on the vehicle information to increase the safety of driving.

The inventor of the present invention hereby presents the preferred embodiments described above to only illustrate the present invention in best practice but not the limitations of the present invention. In some embodiments, when the information of the mileage, fuel level, music output, warning sound, window open/close and rear light of the car are abnormal, the system of the present invention would show low brightness indication on the dashboard, and when the brake lights, rear view mirrors. ADAS, radar cruise system are abnormal, the system would show low brightness flickering indication and, at same time, output low reminding sound, and when the suspension system and engine management system are abnormal, the system would show high brightness flickering indication and, at same time, output high short reminding sound, and when the brake system, steering system and airbag are abnormal, the system would show high brightness fast flickering indication and, at same time, output high fast reminding sound, in another embodiment, the system of the present invention would perform difference feedback operations according to the background brightness of the visual device or the indication of the vehicle information, but all of the scenarios described above just to illustrate the best practice of the present invention, but not the limitations of the present invention.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

1. A system for intuitive human-machine interface, comprising,
a visual device;
an audio device;
a haptic device; and
a system of chip for receiving a data transmitted from one of the following units including at least one electronic control unit, an advanced driver assistance system, a center informative display, and at least one communication system to determine a first feedback level to which the data matches and drives the visual device, the audio device, and the haptic device to perform difference feedback operations according to the first feedback level, to provide an intuitive cognition message to a driver.

2. The system according to claim 1, wherein the system of chip receives at least one data transmitted from at least one of the following plurality of units including a plurality of electronic control units, an advanced driver assistance system, a center informative display, and a plurality of communication systems to determines correspondingly a second feedback level to drive the visual device, the audio device, and the haptic device to perform difference feedback operations according to the second feedback level, and to provide an intuitive cognition message to a driver.

3. The system according to claim 1, wherein the visual device comprises a Head-Up Display (HUD), the HUD performs difference feedback operations, including low brightness on, low brightness flickering, high brightness flickering and high brightness fast flickering.

4. The system according to claim 1, wherein the visual device comprises a LCD display screen, the LCD display screen performs difference feedback operations, including low brightness on, low brightness flickering, high brightness flickering and high brightness fast flickering.

5. The system according to claim 1, wherein the audio device comprises a car audio, the car audio performs difference feedback operations, including no action, low reminding sound, high short reminding sound, and high short fast reminding sound.

6. The system according to claim 1, wherein the car audio performs difference feedback operations, including human voice and/or computer voice reminding operations.

7. The system according to claim 1, wherein the haptic device comprises the center informative display that performs difference feedback operations, including no action, short vibration, constant short vibrations, and constant long vibrations.

8. The system according to claim 1, wherein the communication system is one of Blue Tooth, Global Positioning System (GPS) or 5G communication.

9. The system according to claim 2, wherein the plurality of communication system comprises Blue Tooth, Global Positioning System (GPS), 5G communication or their combination.

10. The system according to claim 1, wherein the data is transmitted by one of the following protocols or their combination, including Universal Asynchronous Receiver/Transmitter (UART), Controller Area Network (CAN), On-Board Diagnostics (OBD), Blue Tooth, GPS and 5G communication.

11. The system according to claim 2, wherein the plurality of data are transmitted by one of the following protocols or their combination, including Universal Asynchronous Receiver/Transmitter (UART), Controller Area Network (CAN), On-Board Diagnostics (OBD), Blue Tooth, GPS and 5G communication.

12. The system according to claim 2, wherein the visual device comprises a Head-Up Display (HUD), the HUD performs difference feedback operations, including low brightness on, low brightness flickering, high brightness flickering and high brightness fast flickering.

13. The system according to claim 2, wherein the visual device comprises a LCD display screen, the LCD display screen performs difference feedback operations, including low brightness on, low brightness flickering, high brightness flickering and high brightness fast flickering.

14. The system according to claim 2, wherein the audio device comprises a car audio, the car audio performs difference feedback operations, including no action, low reminding sound, high short reminding sound, and high short fast reminding sound.

15. The system according to claim 2, wherein the car audio performs difference feedback operations, including human voice and/or computer voice reminding operations.

16. The system according to claim 2, wherein the haptic device comprises the center informative display that performs difference feedback operations, including no action, short vibration, constant short vibrations, and constant long vibrations.
